(19) United States
(12) Patent Application Publication
(10) Pub. No.: US 2007/0224913 A1
(43) Pub. Date: Sep. 27, 2007

(54) Beehive combination bottom board for detection, monitoring and/or reduction of parasite infestations

(76) Inventors: Janet E. Brisson, Grass Valley, CA (US); Michael A. Brisson, Grass Valley, CA (US)

Correspondence Address: Janet E. Brisson, 20693 Dog Bar Road, Grass Valley, CA, 95949, US

(21) Appl. No.: 11/390,690

(22) Filed: Mar. 25, 2006

(51) Int. Cl. A01K 47/00

(52) U.S. Cl. 449/3

(57) ABSTRACT

An apparatus and method for observing, trapping, reducing and controlling mites which infect and kill honey bees in a beehive. A screen, preferably permanently installed in the bottom board, separates mites from the bees, and sub-board below the screen traps the mites to prevent re-infestation or allows detection and observation. Large air space between the sub-board and screen and the use of a sticky substance on the sub-board prevent bees from climbing up into the beehive and prevent re-attachment and facilitates monitoring and the use of inert powder such as powder sugar. The sub-board is accessible from the rear of the beehive so that the entry and exit of the bees into and out of the beehive are not disturbed and also from the front when rear access is not available allowing this board to have a double use.

### BACKGROUND OF THE INVENTION

Detection and control of infestation of bees by parasites, such as mites, has become of great importance since discovery of Varroa mites (VARROA-JACOBSONI) an external parasite of honeybees, were detected for the first time in North America in September, 1987. Within a short period after being infested with Varroa mites, healthy and productive bees begin a rapid decline and within two to three years after initial infestation, a beehive will be totally destroyed. Varroa mites are now found throughout most of the world. The need for more comprehensive surveys and better detection techniques including an improved, rapid and accurate screening detection and control system for Varroa mite infestation is important.

The elements of a beehive include vertical panels that are placed in at least one box like chamber called a super that is mounted on a bottom board which sits on the ground or on a stand. The bottom board has traditionally been made of a wood platform with three sides, with the open side called the front of the beehive. Bees work to build a honeycomb on the vertical panels and fill the honeycomb with either brood (bee eggs and larvae) or honey. The operator of the hive then removes the vertical panels to examine bees or removes honey from the honeycomb.

The VARROA mites, as external parasites of bees, are prone to fall off the bees, a characteristic that allows easy detection of infestation. It is common to find VARROA mites on the bottom board of a beehive after infestation has occurred, those mites falling off the bees inside the beehive. It is therefore helpful if there is a way to detect infestation early for accurate monitoring and control.

Current varroa mite control strategies typically include the use of chemical acaricides. Introducing chemical pesticides into the beehive is a primary line of defense to varroa mite infestation. It will be appreciated, however, that the use of chemical pesticides in beehive can create numerous undesirable effects. For example, chemical varroa mite controls may inadvertently cause selection for resistance to the treatments due to slight genetic variations in the mites. This resistance may render the treatment ineffective due to the brief morphology of varroa mites, and may result in future generations of chemical-resistant mites. Furthermore, some chemical treatments may leave measurable traces of the chemical behind in the wax, possibly detracting from the wholesome image of honey and other products of the beehive. Chemical treatments may also inadvertently cause selection of undesirable traits in bees, including increased susceptibility to future parasitization. Chemical mite controls may also place a significant financial drain on beekeepers.

Apiarists today cannot expect to keep bees without using at least a mild type pesticide, Apistan, and there are signs that the Varroa mites have evolved a resistance to it.

Attempts at more organic varroa mite controls have typically involved labor-intensive procedures. For example, drone brood foundation placed in the beehive for the purpose of trapping varroa mites may involve the beekeeper in multiple added visits to each beehive. Other beehive manipulations include the use of electrically heating the comb.

Some problems have been partially solved by the implementation of screen boards placed in the bottom of beehive either above the existing bottom board or removing the bottom board altogether. These screened anti-varroa boards are an environmentally friendly method that have helped slow the rate of infestation and allow the level of infestation in colonies of bees to be determined. With mites becoming resistant to the mild chemical Apistan, rather than killing the mites, the pesticide simply knocks them out. With screen boards, the mites that are knocked off of the bees are ideally trapped below the screen. When they revive, they are ideally, unable to crawl back to the beehive and reinfest the bees.

These boards are typically a one-piece screened bottom board having mesh openings sized to permit passage of infesting organisms while preventing passage of bees. Sometimes these boards are made to hold removable trays that could be coated with a sticky substance like vegetable oil, shortening or petroleum jelly and used to monitor and/or trap varroa mites. This is particularly useful for rapid detection for the presence or absence of infesting organisms both in beehive under field conditions and for evaluating the effectiveness of miticides for killing mites. These apparatuses also facilitate common non-chemical mite control methods, such as powdered dusting substances (i.e.: powder sugar or flour) and smoking with natural substances (i.e.: tobacco, grapefruit leaves or eucalyptus leaves), and sprays of oils; and chemical pesticides such as Apistan.

However, these boards are not yet well-configured to provide effective pest control, especially against varroa mites.

U.S. Pat. No. 4,867,731 provides a device that helps determine the presence or absence of VARROA mite infestation. The '731 patent specifically comprises an insert, or sub-board, which slides through an access opening, and is placed on the bottom board of a beehive. The U.S. Pat. No. 4,867,731 insert includes a sticky trapping surface of the sub-board that is positioned under a fine mesh screen. After the U.S. Pat. No. 4,867,731 device is inserted into the beehive mites that fall off bees in the beehive while over the fine mesh screen fall through the screen and onto the sticky trapping surface. The screen is such that it will permit VARROA mites to pass through while keeping bees from passing there through. When the VARROA mites contact the sticky trapping surface they are essentially rendered immobile to prevent reattachment or reinfestation by the mites.

The U.S. Pat. No. 4,867,731 device has a number of disadvantages. First, the screen and sub-board sit directly on the bottom board; allowing ants, beehive beetles and wax moths to nest under the sticky board. Second, the sub-board entry space is limited and cannot be used with powdered sugar, as there is no way to clean without dismantling the beehive. Third, the narrow space between the sub-board and screen allows debris that has passed through the screen to fill the space as well as allows mites to climb the walls to the wire. Once up to or near the wire, the mites climb back onto the bees. If the mite falls through the screen but not onto the trapping surface, or if a mite falls upon other debris already on the trapping surface, the mite will not be stuck and could possibly scale the walls of the bottom board and reattach to a bee.

Further, the U.S. Pat. No. 4,867,731 insert is installed and removed through the same access opening through which bees enter and exit the beehive. This is disadvantageous because it is intrusive to the bees and negatively affects their production. Installing and removing the U.S. Pat. No. 4,867,731 device at the access opening utilized by the bees is disadvantageous because, particularly for hobbyists, novices and children who maintain a beehive, a much greater risk of being stung by one of the bees is created.

U.S. Pat. No. 6,468,129 utilizes acknowledges this fault of using the sub-boards through the same front opening and that the bees use, and this patent uses only a rear entrance. The disadvantage to this is that beehive are quite often set up on pallets or against fences and/or a combination of both. There are quite a number of people who move bees on pallets where they do not have access to the back and can only work their bees from the front.

In our case, we are keeping bees along a fence line and we would need two sets of traps to accommodate our needs.

There is thus identified a need for a screened bottom board construction incorporating a mite trapping device that may be installed and removed without interfering with bees entering and exiting the beehive, while allowing the beehive to be placed anywhere that is convenient, where on pallets, back to back or against a fence and which eliminates the safe landing areas for mites that fall off the bees while in the beehive, and which includes provisions to keep mites that fall onto the sticky trapping surface from getting to the walls and scaling the walls to reattach to the bees in the beehive.

Potential Advantages

Devices and methods as discussed herein may be but are not necessarily configured as:

a beehive with a mite trapping device that aids in the detection, monitoring and elimination of VARROA mites without increasing the risk to the operator of being stung.

a beehive having mite trapping provisions that is unobtrusive to bees working in the beehive.

a beehive with mite trapping provisions comprising a sub-board, which can be made sticky by covering with sticky substance that is accessible from the rear and front of the beehive.

a beehive having a screen permanently built into and covering the entire area enclosed by the upstanding walls and landing of the bottom board.

a beehive having a sub-board that is readily accessible from the beehive to remove and examine mites that are trapped thereto without interfering with bees entering and exiting the beehive.

a sub-board for a beehive having perimeter enclosing with a large enough vertical space that prevents mites climbing or jumping up through the screen and from reattaching and reinfesting bees in the beehive.

a beehive having a bottom board that remains functional during removal, maintenance and replacement of a pest-trapping sub-board received therein.

a beehive having a bottom board that does not necessitate a solid bottom to keep separate parasites from bees in the beehive while keeping vermin and robbing bees from entering said beehive.

a beehive having a bottom board that remains dry due to a rain guard that prevents rain from hitting the sub-board and entering the beehive.

a beehive having a bottom board that does not necessitate a solid bottom, by removing the sub-board to allow mites to drop to the ground as a means of mite control in addition to allowing ventilation and increased air circulation of the beehive that has been proven in certain cases to increase bee brood production.

a sub-board and screen having a vertical space there between to make use of optional inert powders as a means of mite control.

a beehive with a safe and unobtrusive way of smoking the bees by providing a covered hole in the rear that's created in such a way to prevent rain from entering.

to provide a way to create a traditional closed bottom board that facilitates the use of vapor methods of mite control, such as Api-Var Life and Oxalic Acid.

to provide a way to create a traditional closed bottom board to constrict ventilation and provide extra warmth to a new or weak beehive.

to provide a way of extra insulating the bottom of the beehive by having the means of holding two boards, and sub-board and a second sub-board to create a warming air space and providing mite control at the same time.

These and other specific devices and methods will be apparent from a review of the following specification and accompanying drawings.

### BRIEF SUMMARY

Described herein is a bottom board of a beehive that has a screen installed in it. There is an air space, preferably large, between a pest trapping insert or sub-board of the bottom-board and the screen, and the optional use of a sticky substance on the sub-board that is inhospitable to the pest, prevents pests from climbing up into the beehive and prevents re-attachment of the pest to the bees. The pest trapping sub-board works best with pests that do not fly, where the pest must walk or crawl to reinfest bees.

Preferably the pest-trapping sub-board is removable from the bottom board through both a rear access and a front access. The sub-board is positioned below the screen, which may or may not be permanently installed in the bottom board so that, when the pest-trapping sub-board is installed in the bottom board, mites or other pests will pass through the screen from the remainder of the beehive and land on the sub-board. Preferably this pest-trapping sub-board is accessible through a rear access opposite to the front wall of the bottom board, the bees entering the beehive through one or more slots in the front wall. This allows removal and replacement of the sub-board with minimal intrusion on the bees, which necessarily minimizes the risk of being stung and also minimizes disruption of the bees in the beehive. Not all beekeepers will always have access through the rear, and therefore preferably the sub-board has a pass-through entry and exit from both the rear and front of the bottom board.

The rear access for the sub-board may comprise a slot in the rear wall of the bottom board through which the sub-board passes, and the sub-board may also have slots in or a ledge on the side walls so that the sub-board is free to slide in and out. It is particularly preferred to coat the sub-board with a sticky or otherwise inhospitable substance to create a treated sub-board that acts as a trap for pests such as parasitic mites. An inhospitable substance deters the pest from exiting the bottom-board. A sticky substance thus holds the parasite and prevents its escape or reattachment to a bee in the beehive.

The sub-board of the bottom board is a sufficient distance from the screen to prevent the pest (e.g. mites such as Varroa mites) from climbing back along generally vertical walls of the side walls to the bees. The distance may depend upon the presence and type of inhospitable substance. Preferably the distance is selected assuming that no inhospitable substance will be present on the sub-board. The side walls have notches in them that hold the sub-board. When the sub-board is removed, mites are impeded from climbing into the hive because mites have to crawl upside down on the ceiling of the notched area.

The pest-trapping sub-board of the bottom board may or may not be present. The bottom board may be configured to not have a floor so that it is open at the bottom regardless whether the sub-board is present or not. There are several opinions that an open bottom board, with or without pest-trapping sub-board, promotes the bee colony to be healthier and more productive.

Additional slots may be provided in the bottom board for additional sub-boards to be inserted to provide extra insulation in cooler weather if desired.

The bottom board may optionally have one or more slots to allow a sub-board to be installed above the screen to use as a traditional floor to allow the bees do their own cleaning.

The disclosed bottom board and beehive incorporate changes that preferably make the treatment of mite problems safer for the user and which improve the effectiveness of the mite eradication there from.

In one instance, the bottom board has a rear smoke hole and cover so that the keeper can safely work the bees from the rear of the bottom board or beehive. The smoke hole makes it possible to thoroughly fill the beehive with smoke. The smoke may hit a bar on the opposite of the cavity to be directed upwards, rather than out the front of the beehive through the slot serving as the bee entry to the beehive.

The bottom board may be formed of any material that is not detrimental to the bees above it, such as rot resistant redwood for front and back legs of the bottom board to prevent termites and rot from destroying the bottom board.

Also provided is a beehive comprising of a beehive body and any of the bottom boards as described herein.

Further provided is a method of controlling mites in a colony of bees in a beehive. This method comprises separating the bees from a lower area of the beehive a sufficient distance that a sufficient number of treated mites cannot return to reattach to the bees, and treating said mites in the lower area to impede their ability to crawl up sidewalls of the beehive. Sufficient mites or other pests or organisms are removed from the colony that the colony remains self-sustaining.

Also provided is a method of monitoring mites or other pests or organisms. Bees are separated from a lower area of the beehive a sufficient distance that a sufficient number of treated mites cannot return to reattach the bees, and treating the mites in the lower area to retain most or all of the mites on a removable board that allows the mites to be counted.

These and other devices and methods are apparent from the text herein.

### BRIEF DESCRIPTION OF THE DRAWINGS

FIG. 1 is a front view of the apparatus of the invention and a traditional Langstroth beehive body, the standard beehive body of the beekeeping industry, forming a complete beehive. No additional equipment need be bought or used.

FIG. 2 is a front view of the system of U.S. Pat. No. 4,867,731, with beehive bodies stacked in a traditional manner.

FIG. 3 is a front perspective view of the invention, the bottom board with the front door off, interior front slots exposed, and the sub-board shown in place under the screen and out of the box.

FIG. 4 is a rear perspective view of the disclosed bottom board with the door off, the sub-board being removed, and smoke hole with cover.

FIG. 5 is a front view of a device as disclosed in U.S. Pat. No. 6,468,129 showing a sub-board in place.

FIG. 6 is a side view of a device as disclosed in U.S. Pat. No. 6,468,129 showing a sub-board in place and slid out.

FIG. 7 is a side view of the disclosed bottom board showing the entry slots for the sub-board (711) with the sub-board in slot #1 (702, 745) and a sub-board (711) in slot #2 (701, 739) which is the main position for insulating the beehive. This arrangement still allows one to have a sub-board as a sticky board to trap and monitor mites from the front entrance.

FIG. 8 is an item for sale, a Dadant Varroa screened bottom board.

FIG. 9 is an item for sale, a Dadant plastic Varroa stainless screened bottom board.

FIG. 10 is an item for sale known as Dadant Varroa Screened Wood Bound Bottom Board.

### DETAILED DESCRIPTION OF PREFERRED EMBODIMENT

While various pieces of the beehive and bottom board are described as “boards,” nothing in this description is to be construed as limiting the described devices as made of wood. The devices may be formed of any material that is compatible with bee tending, considering the particular configuration of the bottom board or beehive. The bottom board (typically configured to exclude bees) may be formed of and/or coated with a material that is inhospitable to bees as well as to the pests to be controlled, but due to its location, a bottom board so configured is one that is compatible with bee tending.

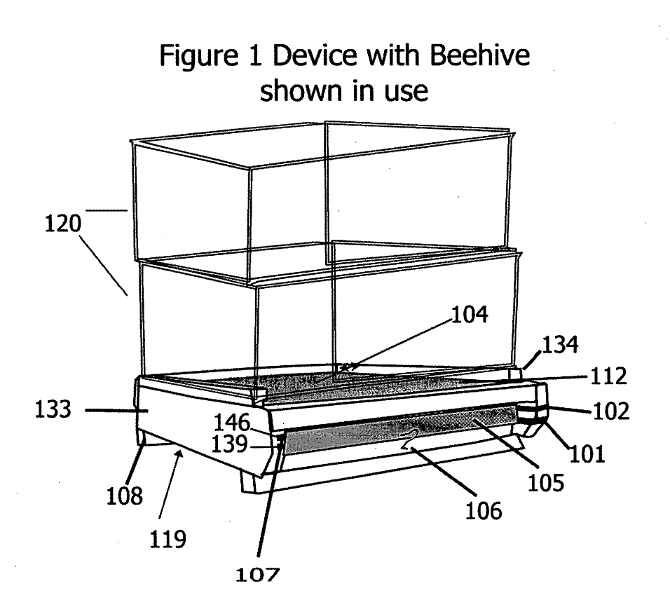

FIG. 1 is a perspective front elevation view of the apparatus 119 and how it fits in relationship with a traditional Langstroth size beehive, which usually consists of open boxes of a specific size called beehive bodies, brood chambers, or supers 120. The bottom board of FIG. 1 is used in conjunction with a beehive 120, which may be a multi-component box structure such as that shown in FIG. 1. Existing devices and the disclosed bottom board may use the beehive 120 structure shown in FIG. 1; specifically, a bottom board 119 on which multiple components are stacked, such as a brood chamber 120 where bees build honeycomb and store honey. Additional components not shown, such as a queen excluder, honey super chamber, entrance reducers, top screen, etc. are also stacked on the bottom board 119. No changes or additions to the elements stacked on top of the bottom board 119 are necessary.

This bottom board 119 has front 107 and rear 108 feet that elevate the body off the ground. The beehive bodies 120 are stacked on the side walls 133, 134 providing an opening 112 through which bees enter and exit the beehive. Screen 104 prevents bees from entering the bottom board containing the pest-trapping sub-board. Screen 104 allows pests that have been loosened from bees within the beehive to fall to the pest-trapping sub-board or to the ground. The removable front access plate or door 105 fits between the two side walls 133,134 and locks in place with a simple locking device 106 and allow the beekeeper access to the pest-trapping sub-board and any other sub-boards (also inserted removably or permanently in slots 101, 139, 146, and 102) within bottom board 119. Bottom board 119 may have a similar set of slots and removable access door positioned on the back side of the bottom board.

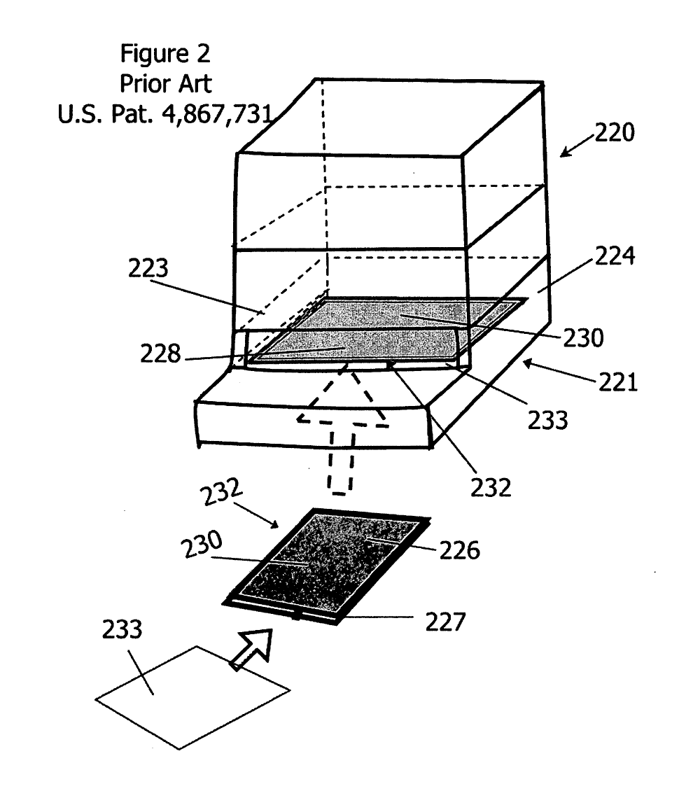

FIG. 2 depicts a known screened insert 232 from U.S. Pat. No. 4,867,731. The screened insert 232 comprises of a wooden frame 226 with internal grooves 227 for retaining a sub-board 233 and having an overlying screen 230, which has openings sized to permit passage of infesting organisms while preventing passage of bees. The screened insert 232 slides into the beehive 220 through the front gap 228 of the bottom board 221 between upstanding side wall 223 and upstanding side wall 224 and sits on floor 229. This gap 228 provides access means for bees to enter and exit the beehive 220. A sub-board 233 slides underneath this screened insert 232 by inserting sub-board 233 into the internal grooves 227 of the wooden frame 226.

A significant disadvantage of the known mite trapping device of FIG. 2 is that many mites will fall off bees and onto the frame 232 around the fine mesh screen 230, and thus do not fall through to the mite trapping board 233. Those mites are free to re-infest the bees within the beehive 220. Another disadvantage of known screen insert 232 is the narrow space between the screen 230 and the sub-board, which can quickly fill with debris and allow the mites to simply walk back up onto the debris into the beehive. One more disadvantage of the known screen insert 232 is that when the apiarist installs or removes the screened insert 232 from the entrance gap 228 as in FIG. 2, this action interrupts bees entering and exiting the beehive 220 and, because the user is working in close proximity to the main entry and exit access for the bees, there is an increased risk of being stung. In addition, the intrusion impacts the production by the bees.

The infestation of bees by parasites, specifically the VARROA mite, has created a need to improve the known FIG. 2 screened insert 221. Once an infestation of a beehive of bees by VARROA mites occurs, the entire beehive is at risk. The entire beehive can be eliminated within two years after first infestation occurs. As such, it is desirable to provide a beehive structure that eliminates or reduces the incidence and effect of VARROA mite infestation. Notwithstanding such, the principles of the present invention may be employed as an isolation or separation device for any parasite or impurity that falls off naturally within the FIG. 1 beehive 120 to the bottom of the beehive 120 through the screen 104 of the bottom board 119.

An objective of one present bottom board 119 is to separate and keep separated VARROA mites from the bees such that the parasitic VARROA mites (or other pests that preferably do not fly at all or at a stage of life in which they infest bees) cannot reattach to the bees. This can include the use of a removable bottom plate that can be accessed with minimal intrusion upon bees entering and exiting the beehive 120 both from the rear and the front.

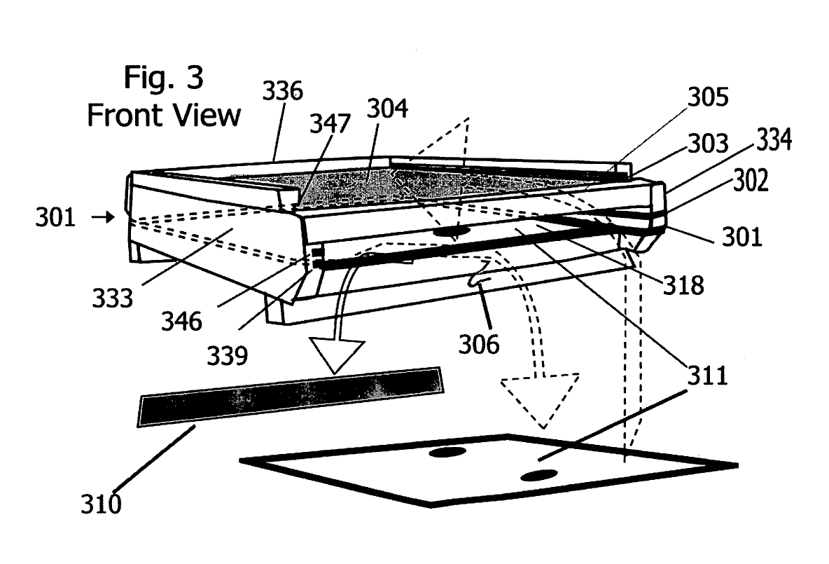

The bottom board 300 illustrated in FIG. 3 has a mesh screen 304 permanently installed therein. The screen 304 covers the entire area and expanse between the front landing board 305, rear wall 336 and side walls 333, 334 with no border or ledge upon which organisms such as mites or other crawling insects may land. The screen is permanent so that it is not necessary to provide the screen in a frame. Because the screen 304 is permanently installed flush with the landing 305 and you insert the Varroa trapping sub-board 331 into grooves 346,334,339,301 below the landing 305, putting Varroa trapping inserts into the beehive is not necessary and does not disturb the bees. This is in contrast to the known bottom board 221 which necessarily had to provide access to the interior to install and remove the insert screen 230, making the inventive bottom board as disclosed herein particularly preferred.

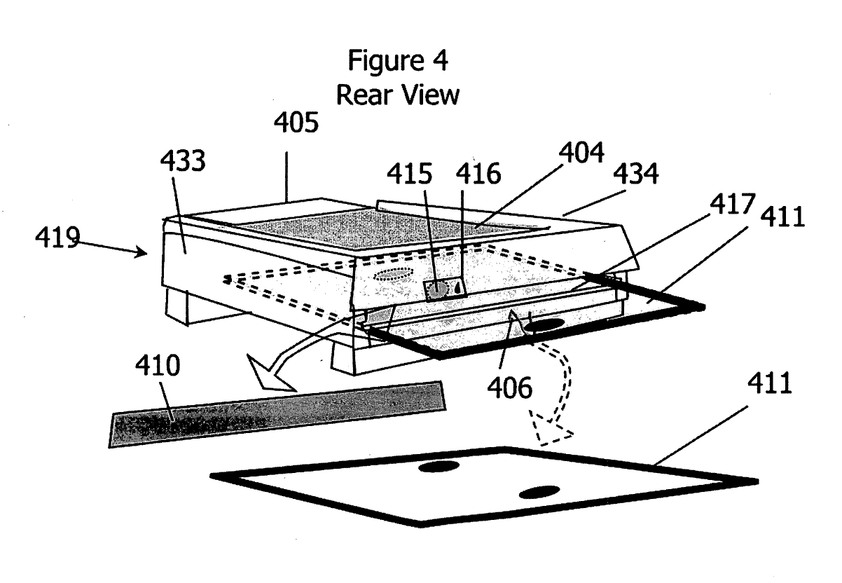

As shown in FIG. 4, in order to remove the VARROA mites or other parasites or debris falling through the screen 404, it is desirable to provide means for removing the sub-board 411 onto which VARROA mites and other parasites and debris that fall through the screen 404 land without disturbing bees as occurs when guard bees perceive a threat at the beehive entrance by the landing board 405. In FIG. 4, a rear access 417 means for removing the sub-board 411 at a location opposite or sufficiently distant from the location at which bees enter and exit at the landing board 405 is preferred, in order that mites and other parasites and debris thereon may be removed without interrupting or intruding upon the entrance and exit of the bees, which occur at the front landing board 405 and between the two upstanding walls 433, 434. Particularly for beehive hobbyists, including many children, this is a significant advantage because it reduces the incidence of exposure to the bees and the likelihood of being stung.

FIG. 3 shows the front access to remove and replace the sub-board 311. This is provided through sub-board entry space 318 formed by the side walls 333, 334 and sub-board receiving slots 302, 346 that run the length of each the side walls 333, 334. Although it is not a necessary element of the preferred bottom board 300, this gives beekeepers the option of having a front entry 318 for their sub-boards 311. There are quite a number of people who move bees on pallets or keep beehive along fences where they do not have access to the back and can only work their bees from the front of their beehives. This is a desirable feature, as the bee keeper only needs one type of bottom board to cover the options of where the beekeeper places beehives.

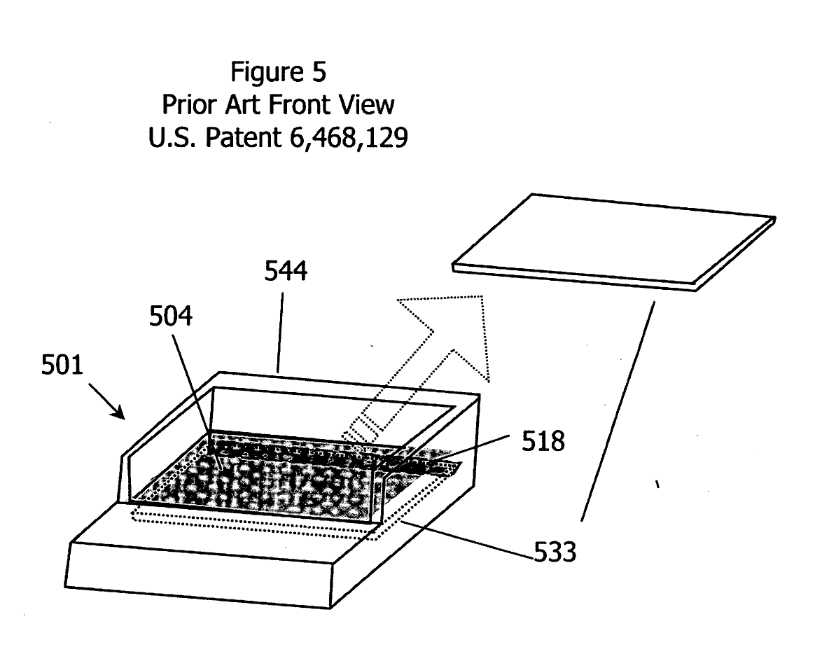

FIG. 5 shows a device from U.S. Pat. No. 6,468,129 that includes a removable sub-board 541 that can only be inserted through a rear entry 543. In the inventive bottom board illustrated in FIG. 3, a sub-board 311 of a bottom board 301 disclosed in the present application can also be inserted and removed through entry slot 318 in the front of the bottom board (FIG. 3) and slides within slots 302 and 346 in the side walls 333, 334. Providing a front access below the landing board 305 to insert and remove the sub-board 311 allows a user to remove varroa mites from the beehive when the rear access is blocked. There is minimal interference to the bees entering and leaving the beehive as the space 318 where you insert the sub-board 311 below the front landing board 305 of the beehive. It is noted that some bees will land on the sub-board 311 during the day when activity is high as you are inserting it into the space 318 through the lower slots 302, 346. As mentioned, this is not the most desirable way to use the sub-board 311. It is preferred as in FIG. 4 to insert and remove the sub-board 411 from the rear of the bottom board 419, but you have that option.

As discussed above, it is known (FIG. 2) to use a trapping substance on a mite trapping sub-board 233 so that, when mites contact the sub-board 233, they stick to the sub-board 233 and cannot move, thereby preventing re-attachment or re-infestation of the bees. Several examples of such a trapping substance that may be used in the device of the invention are vegetable oil, shortening or petroleum, although other substances may be used without departing from the principles of the present invention. The use of a trapping substance on the sub-board 233 of the present invention is specifically contemplated so that sub-board 233 comprises a sticky sub-board 233. However, even with a trapping substance applied to create the sticky sub-board 233, there is still a danger of enough debris falling that it fills up the space between the sub-board 233 and the screen 230 that mites that land on debris that has previously fallen onto the sticky sub-board 233 and covered the trapping substance, such that mites can crawl back up through the screen 230 and re-attach and re-infest the bees in the beehive 200 if the screens 230 and sticky boards 233 are not maintained often.

In FIG. 3, a removable door front 310, held in place by a simple locking device 306 can be removed as shown, allowing the inner portion of the apparatus to be accessible. Such inner portions may include, for example, two lower slots, 302, 346 and 301, 339 that could each hold a sub-board 311. The removable door 310 allows one to remove the sub-board 311 from the front without scraping off mites or powder sugar. The door prevents bees from entering and getting covered with oil or sugar or reinfested with mites. The door 310 prevents bees from entering below the screen 304 and getting covered with oil or sugar or reinfested with mites trapped below the screen. Bees are naturally attracted to sugar that is left below the screen 304 and thus it would be important to keep them out of this inner space. Bees may therefore be dusted with an inert powder such as powder sugar to help dislodge mites without fear that the bees will enter the inner space 318 and be reinfested with mites trapped below the screen.

In FIG. 4, a removable rear door 410, held in place by a simple locking device 406 can be removed as shown, allowing the inner portion of the apparatus to be accessible. The removable door 410 allows one to remove the sub-board 411 from the rear without scraping off mites or powder sugar. The door 410 prevents bees from entering below the screen 404 and getting covered with oil or sugar or reinfested with mites trapped below the screen. Bees are naturally attracted to sugar that is left below the screen 404 and thus it would be important to keep them out of this inner space. This combination accommodates the method of dusting bees with an inert powder such as powder sugar without fear that the bees will enter the inner space 417 and be reinfested with mites trapped below the screen 404. As noted previously, it is helpful to have both front and rear doors so that the bee keeper has flexibility in placing beehive in various locations to provide good access for bees and for the keeper.

FIG. 5, front view of U.S. Pat. No. 6,468,129 depicts a rear entry bottom board 501 with a screen 504 permanently installed in said bottom board 501 wherein said screen 504 covers the entire expanse between said upstanding walls. FIG. 5. shows a small space 518 created by a slot cut into the rear wall 544 here the sub-board 533 narrowly fits in. When removing the sub-board 533, the space is so narrow that it is hard to remove the sub-board without the slot 518 in the rear wall 544 scraping mites off the sub-board 533, and it is virtually impossible to remove the sub-board 533 without scraping off any type of powdered sugar treatments without having the powdered sugar fall into the bottom of the beehive. In FIG. 3 illustrating our bottom board 300, the front 318 entry space is preferably of sufficient size to allow for debris from mites, bee feces and pollen to build up and be removed without scraping the debris off the. In the disclosed device of FIG. 4, the rear space 417 is preferably of sufficient size to allow for debris from mites, bee feces, and pollen to build up and be removed without scraping the debris off the board along the bottom of the rear rain guard 444.

One procedure to dust bees: Sugar Drop Method: FIG. 1, simply pour ½ pound of powder sugar on top of the frames of the top most super 20, (usually done twice a year when honey crops are removed and in place of using the chemical fluvalinate i.e.: Apistan) using a brush, you would work the powder sugar between the frames. The bees become coated with sugar and the dustiness helps detach the mites. Bees grooming themselves further dislodge the mites, which drop to the ground.

With the above known references, none of these methods allow for the convenient removal of the amounts of sugar that needs to be used to maintain a viable bee colony. The powdered sugar does not kill the mites, just detaches them from the bees. If you allow for the powder to fall to the ground by removing the sub-board 533 in FIG. 5, ants can get to an area where you can not reach without the inconvenient task of taking apart your beehive. If you have a screen 230 on top of a bottom board 221 as in FIG. 2, the area beneath the sub-board is also impossible to clean without taking apart your beehive. Ant infestation and infestation by other insects drawn to the sugar is undesirable. Not only ants can nest there, but also small hive beetles and wax moths can live under a sub-board 233 and on top of the bottom board 221. In FIG. 1, the disclosed bottom board 119 will solve these problems by e.g. having large spaces 117 with closeable door(s) 110 where you slide the sub-board 111 out of slots 102, 146 for removing debris, sugar, and bee feces without knocking the debris or powder sugar to the ground or onto a bottom board where the mites are free to climb back to an area where there are bees that could become reinfested. Our bottom board 119 can prevent ant, beehive beetles and wax moth infestations by removing concealed spaces and providing a trap to catch beetle and moth larva. This applies to the device of FIG. 3 and its rear access door 310 as well.

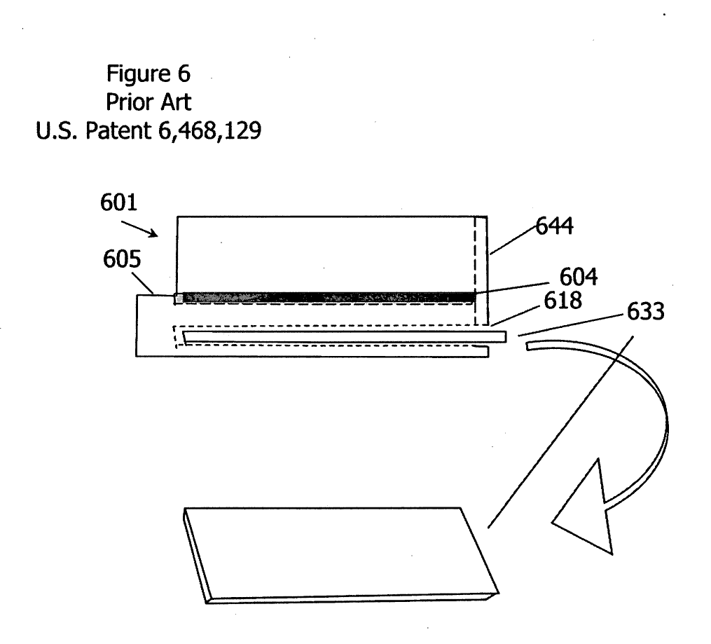

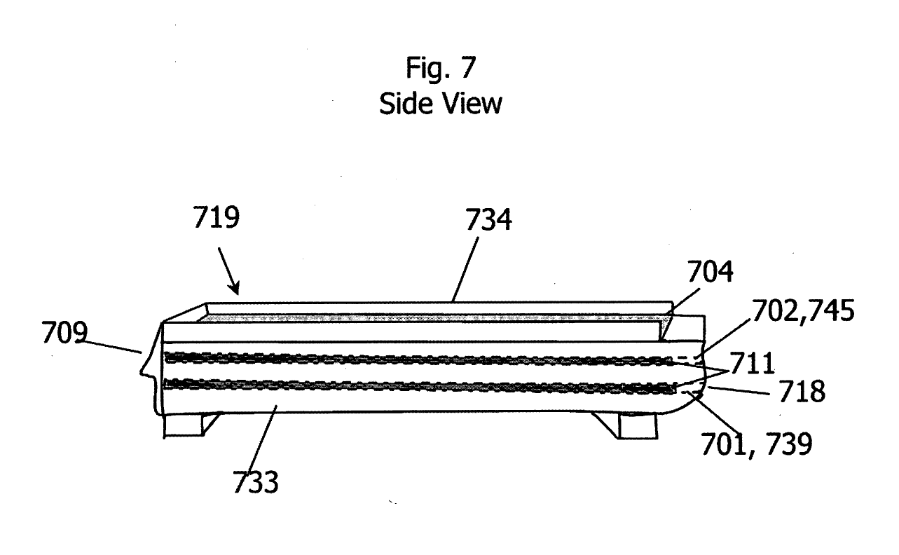

In FIG. 6 in the rear view U.S. Pat. No. 6,468,129, the sub-board 633 has rear entry into the bottom board 601. Since apiarists are recommended to tilt their beehive from 1″ to the back to ¼″ to the front to prevent rain from hitting the front landing board 605 and entering the bottom board 601. This creates an opening that would direct rainwater to enter through the rear entry 618 and on top of the sub-board 633 that needs to slightly stick out so you can retrieve it. The rain guard 709 on the rear of our bottom board 719 in FIG. 7 diverts the rain and keeps the beehive dry.

Another feature shown in FIG. 4 is a smoke hole 415 with a cover 416 located on the rear of the bottom board 419. This allows smoking the bees, a procedure of blowing smoke into the beehive to quiet the bees. FIG. 2 shows where, traditionally, a beekeeper would put the nozzle of his smoker against the entrance space 228, which greatly disturbs the bees and also increases the risk of being stung. One advantage of the disclosed bottom board of FIG. 4 is to be able to force smoke into the beehive from the back. With the onset of Africanized Honey Bees invading the United States, beekeepers have found that they can be manageable when applying smoke to the hive before working their bees. Being able to approach the hive from the rear and blowing in smoke through this hole 415 averts alerting these fearful bees and invoking attacks. The cover 415 prevents bees from entering the space between the screen 404 and the sub-board 411 where they could reinfest themselves with mites. The cover 415 also prevents rain and moisture from entering the beehive through entry space 417.

Another feature shown in FIG. 7 of the disclosed bottom board 719 is that it may be configured to insulate the bottom of the beehive during cold weather to prevent chilling the brood and increasing mite production (Experimentation of Anti-Varroa Screened Bottom Board, Final Report by Jean Pierre Chapleau. March 2003 pg. 12) by adding another sub-board 711 into a second lower slot 701, 739 located beneath the screen 704 and beneath slots 702, 745 where it allows insulating air to be held between the two sub-boards 711. This is provided through sub-board front entry space 718 formed by the side walls 733, 734 and sub-board receiving slots 745, 702 and 739, 701 that run the length of each of the side walls 734, 735.

The ability of having the choice of using sub-boards or leaving the bottom open and exposed to the ground have been the topic of much controversy.

As a mite deterrent, more and more people and institutions are leaving off the bottom boards entirely, allowing the mites to fall to the ground and hopefully perish there. In warmer drier climates there has been success, but in colder climates there has been mixed reviews.

The study by Jean Pierre Chapleau completed in March of 2002 tested anti-varroa screen bottom boards within, taking place in Quebec, Canada. This study showed increased varroa mite infestations on beehive that the bottom board was removed entirely, chilling the brood. They sited the following: “Numerous references can be found in scientific literature confirming that lower temperature conditions enhance the development of varroa populations.” “It has also been noted that when infested adult bees were exposed to variable temperatures in laboratory conditions, the percentage of varroa mites falling from the bees increased with the elevation of the ambient temperature. Here again we can deduce that the brood chamber temperature should not be lowered.” Our solution to this dilemma was to have the disclosed bottom board 719 of FIG. 7 allow for a variety of combinations to take advantage of any type of climate or conditions. By inserting a sub-board 711 in the lower slots 701, 739 and inserting a second sub-board 711 in the upper slot 702, 746 located below the screen 704. This still allows you to use the top board as a mite deterrent by applying oil to the top sub-board. You can remove sub-boards 711 entirely to take advantage of warm weather and no maintenance (of keeping boards clean). Compared to just placing the beehive on blocks without bottom boards, having some type of screen prevents rodents from entering and reduces robbing.

In FIG. 3 of our disclosed board, we place two more slots 303, 347 to allow for the sub-board 311 to be placed on top of the screen 304 to mimic a traditional floorboard. There would be no mite protection. You would use this configuration if beehive were kept in remote areas where you would not check and clean them as often as you would like. Bees are naturally hygienic and spend a great deal of time and energy cleaning the floors of their beehive of all debris, including their feces, pollen and dead bees. By allowing the bees' feces to collect beneath a screen where bees do not have access unchecked under their home is like us having an open cesspool and would seem very unsanitary. When placed below the screen 304, the bees are unable to clean them; these bottom boards should be monitored and cleaned often. It is recommended by Chapeau to clean your boards once a month to prevent accumulation of beehive debris, which they feel could favor wax month infestations.

There are several screen board trap devices for Varroa mite control for sale found in Dadant 2005 catalogs, page 52.

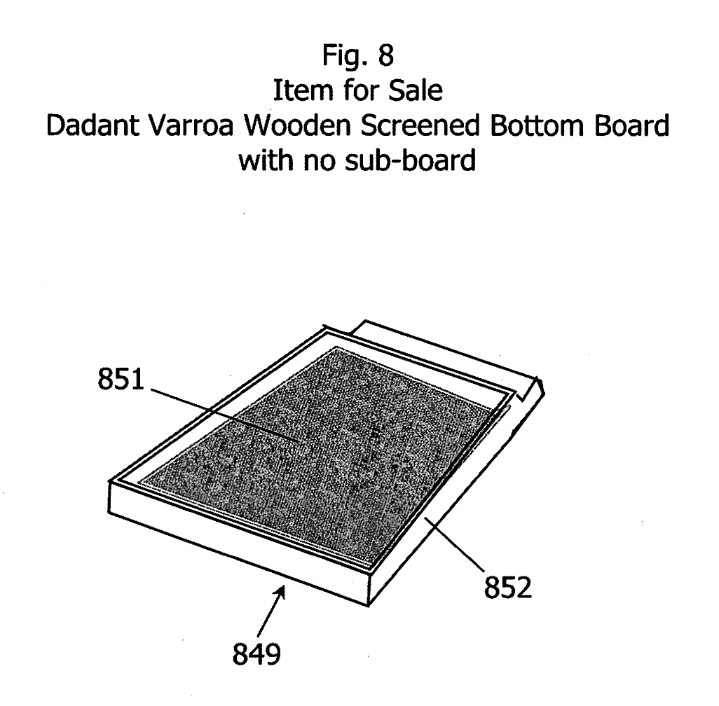

In FIG. 8, Dadant's Varroa Screened Bottom Board 849 has no place to put a sub-board to monitor or trap mites via using a sub-board as a sticky board. The only form of mite control is for the mites to pass through a screen 851, fall to the ground, and be trapped by the wood frame 852. This bottom board sits on and is open to the ground which creates problems that are not present in preferred bottom boards as disclosed herein, where it is possible to monitor mites and use the above mentioned sugar drop method using the sub-board. Without the sub-board, the mites, sugar and debris would fall to the ground where ants could move in. It is not possible to clean beneath the screen or remove the excess sugar without taking apart your beehive. Also there is no smoke hole 415 as in FIG. 4, which makes the only alternative to smoking your bees by the front entrance where you would risk getting stung and upsetting the bees.

This board sits directly on the ground in contract with the earth and is made from pine, which deteriorates over time with in contact with the earth. In FIG. 1 the disclosed bottom board resolves that issue with e.g. redwood legs 107, 108 which is a well-known rot resistant wood.

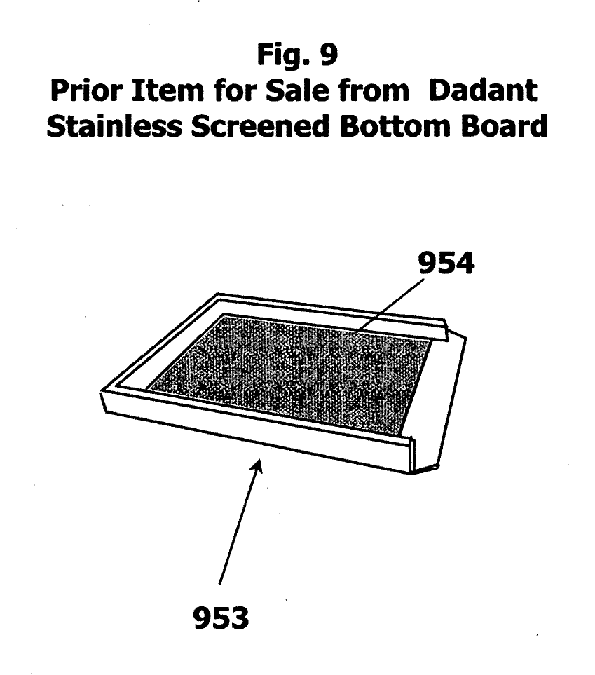

In FIG. 9 Dadant's Plastic Varroa Stainless Screened Bottom Board 953, again, there is no access, either under the front or back, to place a sub-board for monitoring or controlling varroa mites. There is no way of cleaning under the screen 954 without taking beehive apart. In addition, there is no smoke hole 415 as in FIG. 4.

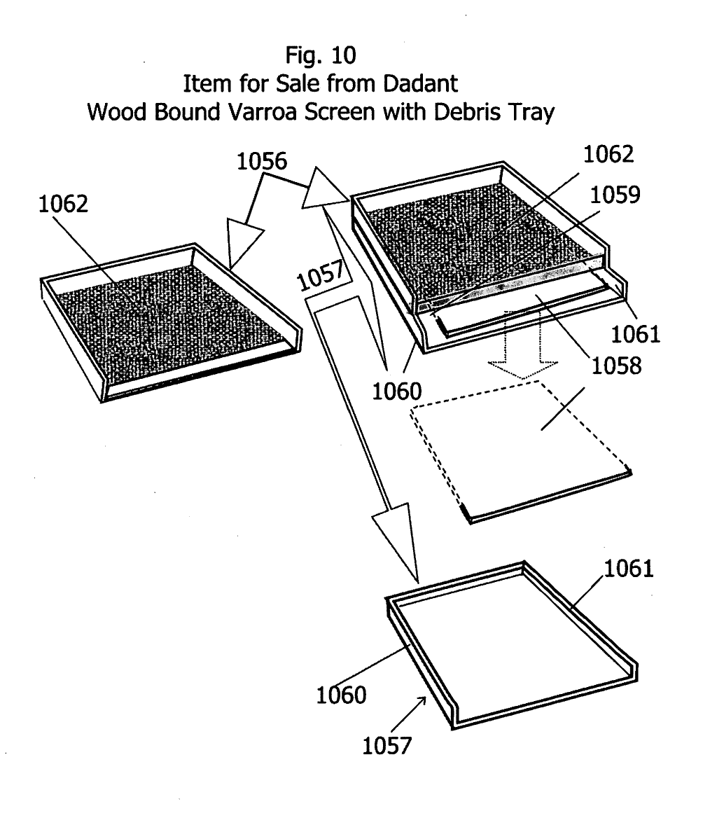

FIG. 10 shows the Dadant Wood Bound Varroa Screen 1056 sitting on top of a conventional bottom board 1057 with a plastic stick board inserted into the gap 1059 made by the two upright walls 1060, 1061 and below the screen 1062. Again, with the only option of having a front-loading sub-board 1058, there is not only the problem of disturbing the bees and the risk of getting stung, there is the additional problem of trapping bees loading a sub-board. Bees' natural flight path causes them to land on the sub-board and get trapped under the screen or coated with oil if used as a mite trapping device. Also, there is also not a very wide gap 1059 between the top of top of the sub-board 1058 and the bottom of the screen 1062 making it difficult to use the sugar drop method. This narrow gap 1059 could also scrape off the mites making it hard to accurately monitor one's mite population.

One more problem is the concealed area between the debris tray 1058 (or sub-board) and the bottom board 1057 provides an ideal area to host wax moth larva, small hive beetles and ant colonies where the bees are unable to monitor under the screen.

A bottom board 419 with sub-board 411 as disclosed in FIG. 4 above may be accessible through a rear access means 417 that is installed opposite to the front landing board 405 with the bees entering the beehive at that point. This allows for removal and replacement of the sub-board 411 from the rear with minimal intrusion on the bees, which necessarily minimizes the risk of being stung. It is also recognized that not all beekeepers will always have access through the rear and thus it may be very desirable to have a pass through entry and exit from both the rear and front of the bottom board.

A bottom board as disclosed herein, especially one with a removable sub-board, allows the apiarist to monitor infestation by mites or other organisms or pests. The apiarist can withdraw the sub-board periodically and count the number of mites on the sub-board, noting the trend of whether the pest population is increasing, decreasing, or remaining steady as well as noting the number of mites in the given period. A sub-board that may be retrieved from the rear of the bottom board allows the apiarist to remove the board with less concern that the bees will be disturbed, thereby minimizing disruption of honey production and minimizing the chances that the apiarist will be attacked by bees from the colony.

Various openings as provided in the disclosed bottom board may have removable covers that prevent rain and pests from entering the bottom board and beehive assembly. As noted, the smoke hole 415 may have a cover 416 such as a piece of wood, metal or other material from which the bottom board is fabricated. The bottom board 419 may likewise have a cover on the front and/or rear 410 to cover the sub-board. The sub-board may 419 have an extension that fits with the front and/or rear sidewall to close the bottom board and prevent rain and pests from entering. Any of the bottom boards disclosed herein may have one or more of such covers.

While certain methods and preferred bottom boards and beehive assemblies have been discussed above, the invention is not limited to the preferred methods and assemblies and is instead to be accorded a meaning consistent with the principles as discussed herein and as defined by the following claims.

What is claimed is:

1. An apparatus for detecting and/or reducing the infestation of bees by organisms, such as parasites, particularly mites, in beehive, comprising:
a) a bottom board comprising upstanding walls, a sub-board, and a screen that define an airspace therebetween,
b) the bottom board having a size and shape defined to interface with a beehive for the bees that sits upon the bottom board,
c) the screen having a mesh that prevents the bees from entering the airspace but allows the organisms and bee detritus to pass from the beehive to the bottom board,
d) wherein the air space has a height sufficiently large that the organisms are hindered from passing from the sub-board through the mesh of the screen, and
e) wherein the sub-board is removable from both the front and rear of the bottom board.

2. An apparatus for detecting and/or reducing the infestation of bees by organisms, such as parasites, particularly mites, in beehive, comprising:
a) a bottom board comprising upstanding walls, a sub-board, and a screen that define an airspace therebetween,
b) the bottom board having a size and shape defined to interface with a beehive for the bees that sits upon the bottom board,
c) the screen having a mesh that prevents the bees from entering the airspace but allows the organisms and bee detritus to pass from the beehive to the bottom board,
d) wherein the air space has a height sufficiently large that the organisms are hindered from passing from the sub-board and through the mesh of the screen, and
e) wherein at the upstanding walls has a space through which the sub-board is inserted that is sufficiently tall so that mite samples, debris and optional powdered sugar treatments are not scraped from the sub-board as the sub-board is removed from the bottom board.

3. An apparatus according to claim 2 wherein the material on the sub-board is a desiccant that removes moisture from the organisms.

4. An apparatus according to claim 2 wherein the material on the sub-board comprises powdered sugar.

5. An apparatus according to claim 2 wherein the bottom board further comprises a slot in at least one of the sidewalls into which the sub-board is slid to facilitate insertion or removal of the sub-board from the bottom board.

6. An apparatus according to claim 2 wherein the apparatus comprises a second, removable sub-board and slots such that the second sub-board is positionable beneath the sub-board.

7. An apparatus according to claim 2 wherein the apparatus comprises an additional, removable sub-board and slots such that the additional sub-board is positionable above the screen.

8. An apparatus according to claim 2 wherein a rear sidewall of the bottom board has a hole or slot sufficiently large to allow smoke to be injected through the hole and into the beehive.

9. An apparatus according to claim 2 and further comprising a beehive fitting upon the bottom board.

10. An apparatus according to claim 2 wherein the bottom board contains a smoke hole or slot.

11. An apparatus according to claim 2 wherein mesh of the screen extends essentially to or to the sidewalls to provide no area upon which organisms may land and avoid falling through openings in the screen.

12. An apparatus according to claim 1 wherein the bottom board further comprises a slot in at least one of the sidewalls into which the sub-board is slid to facilitate insertion or removal of the sub-board from the bottom board.

13. An apparatus according to claim 1 wherein the apparatus comprises a second, removable sub-board and slots such that the second sub-board is positionable beneath the sub-board.

14. An apparatus according to claim 1 wherein the apparatus comprises an additional, removable sub-board and slots such that the additional sub-board is positionable above the screen.

15. An apparatus according to claim 1 wherein a rear sidewall of the bottom board has a hole or slot sufficiently large to allow smoke to be injected through the hole and into the beehive.

16. An apparatus according to claim 1 and further comprising a beehive fitting upon the bottom board.

17. An apparatus according to claim 1 wherein the bottom board contains a smoke hole or slot.

18. An apparatus according to claim 1 wherein mesh of the screen extends essentially to or to the sidewalls to provide no area upon which organisms may land and avoid falling through openings in the screen.

19. A method of controlling mites in a colony of bees in a beehive, said method comprising
a) separating the bees from a lower area of the beehive a sufficient distance that a sufficient number of treated mites cannot return to reattach to the bees and said colony remains self-sustaining, and
b) treating said mites in the lower area to impede their ability to crawl up sidewalls of the beehive.

20. A method according to claim 19 wherein the act of treating said mites comprises exposing the mites to an environmentally-acceptable desiccant.

21. A method according to claim 20 wherein the desiccant comprises powdered sugar.

22. A method according to claim 20 wherein the act of treating said mites comprises of exposing the mites to said desiccant.

23. A method according to claim 19 wherein smoke is introduced into the beehive from behind.
